(19) United States
(12) Patent Application Publication
(10) Pub. No.: US 2015/0115601 A1
(43) Pub. Date: Apr. 30, 2015

(54) GREASE GUN COUPLER

(71) Applicant: Y&D BROTHERS INNOVATIONS INC., Quebec (CA)

(72) Inventors: Daniel Boucher, Quebec (CA); Yves Boucher, Quebec (CA)

(73) Assignee: Y&D BROTHERS INNOVATIONS INC., Quebec, CA (US)

(21) Appl. No.: 14/390,521

(22) PCT Filed: May 17, 2013
(86) PCT No.: PCT/CA2013/050381

§ 371 Date: Oct. 3, 2014

Related U.S. Application Data
(60) Provisional application No. 61/652,372, filed on May 29, 2012.

(51) Int. Cl. F16N 21/04; F16N 5/02; F16N 3/12

(52) U.S. Cl. CPC F16N 21/04; F16N 3/12; F16N 5/02
USPC 285/325

(57) ABSTRACT

A grease gun coupler for delivering grease from a tube of a grease gun to a grease fitting is provided. Insertion of a grease fitting in the coupler pushes in a piston, allows a bias or an operator to push an outer sleeve towards the grease fitting, which biases the ball bearings inwards, thus securing the grease fitting in the coupler. Retraction of the outer sleeve releases the ball bearings, thus allowing another bias to push back the piston and expel the grease fitting.

### CROSS REFERENCE TO RELATED APPLICATIONS

This application claims benefit, under 35 U.S.C. §119(e), of U.S. provisional application Ser. No. 61/652,372, filed on May 29, 2012

### FIELD OF THE INVENTION

The present invention relates to a grease gun coupler. More specifically, the present invention is concerned with a coupler that sealably secures grease fittings of various shapes and sizes.

### BACKGROUND OF THE INVENTION

Grease guns are a common workshop and garage tool used for lubrication. The purpose of the grease gun is to apply lubricant through an aperture to a specific point, usually on a grease fitting. Channels behind the grease fitting lead to where the lubrication is needed. Grease guns can be hand-powered or air-powered (pneumatic). The grease gun can be charged or loaded with any of the various types of lubricants, but usually thick heavy grease is used.

Grease fittings are also called grease nipples, Zerk fittings, and Alemite fittings. They are metal fittings permanently installed by a threaded connection, leaving a nipple connection that the grease gun attaches to. The pressure supplied by the grease gun forces a small captive ball bearing in the nipple to move back against the force of its retaining spring. The arrangement is thus essentially a valve that opens under pressure to allow lubricant to pass through a channel and be forced into the voids of the bearing. When the pressure ceases, the ball returns to its closed position. FIG. 1 comprises an outline of a generic grease fitting. Grease fittings (100) generally comprise a ball bearing containing bulbous head (102) with a neck (104) attached to a threaded body (106). However, grease fittings come in a variety of shapes and sizes. For example, the bulbous heads show variability in diameter and length (being sometimes more elongated, sometimes rather squashed). Further, repeated use and general wear and tear can also alter the shape of the grease fitting. Finally, old grease fittings such as those found on older pieces of equipment and machinery can be slightly different from more recent fittings.

Grease gun couplers are devices that couple the tube of a grease gun to a grease fitting. Conventional couplers use legs to attach themselves to these fittings. However, such couplers wear out quickly because of the way they engage to and disengage from the grease fittings. Slightly worn couplers rapidly cease to hold on to the grease fittings as they should. Another disadvantage of these couplers is that the operator needs to carefully align the coupler on the grease fitting to have a proper connection. As a result of all this, grease leakages at the coupler/fitting junction are quite common.

### SUMMARY OF THE INVENTION

In accordance with the present invention, there is provided:
1. A grease gun coupler for delivering grease from a tube of a grease gun to a grease fitting, the coupler comprising:
   an elongated inner sleeve having a longitudinal axis, a tube attaching end and a grease fitting accepting end,
   a plurality of ball bearings located in a plurality of openings spread evenly around a circumference at the grease fitting accepting end of the inner sleeve,
   an outer ball bearing retaining sleeve axially sliding over the inner sleeve from a first engaged position to a first disengaged position, the outer sleeve having a tube end and a ball bearing engaging end,
   an inner concave ball bearing retaining and grease fitting accepting piston arranged axially and sliding within the inner sleeve from a second engaged position to a second disengaged position,
   first means for biasing the piston toward the grease fitting accepting end of the inner sleeve, and
   second means for biasing the outer sleeve toward the ball bearing engaging end or third means for biasing the outer sleeve toward the tube end,
   wherein the inner sleeve and a bore in the piston together define a passage for the grease along said axis, and
wherein insertion of the grease fitting in the coupler biases the piston away from the grease fitting accepting end to said second engaged position, thereby allowing the second means for biasing to bias the outer sleeve toward the ball bearing engaging end to said first engaged position, thereby biasing the ball bearings inwards toward said axis and securing the grease fitting in the coupler, and wherein retraction of the outer sleeve away from the ball bearing engaging end to said first disengaged position releases the ball bearings, thereby allowing the first means for biasing to bias the piston toward the grease fitting accepting end to said second disengaged position, thereby expelling the grease fitting, or
wherein insertion of the grease fitting in the coupler biases the piston away from the grease fitting accepting end to said second engaged position, thereby allowing the ball bearings inwards toward said axis, thereby allowing pushing the outer sleeve toward the ball bearing engaging end to said first engaged position to secure the grease fitting in the coupler, and wherein pushing the inner sleeve towards the grease fitting accepting end so that the outer sleeve is in said first disengaged position releases the ball bearings, thereby allowing the first means for biasing to bias the piston toward the grease fitting accepting end to said second disengaged position, thereby expelling the grease fitting.
2. The coupler of 1, wherein in said first disengaged position, the ball bearing engaging end of the outer sleeve abuts the ball bearings, thereby maintaining the ball bearings in the openings.
3. The coupler of 1 or 2, wherein the passage for the grease is unhindered along said axis.
4. The coupler of any one of items 1 to 3, wherein the outer sleeve is provided with a lip to improve grip.
5. The coupler of any one of items 1 to 4, wherein at least part of the surface of the outer sleeve is knurled to improve grip.
6. The coupler of any one of items 1 to 5, wherein the ball bearing engaging end of the outer sleeve is partly cut at an angle of about 45.
7. The coupler of any one of items 1 to 6, wherein the inner sleeve is terminated with an outward rim at the grease fitting accepting end.
8. The coupler of item 7, wherein the openings are partially defined by the outward rim.
9. The coupler of item 7 or 8, wherein the rim has a roughly triangular cross section.
10. The coupler of any one of items 7 to 9, wherein the rim is less than about 0.075, 0.06, 0.05, or 0.045 inch in height and less than about 0.025, 0.020, or 0.015 inch in width.
11. The coupler of item 10, wherein the rim is about 0.044 inch in height and about 0.030 inch in width.
12. The coupler of item 10, wherein the rim is about 0.033 inch in height and about 0.040 inch in width.
13. The coupler of any one of items 1 to 12, wherein the openings are bored at an angle of about 60 to about 80° from the axis.
14. The coupler of 13, wherein the openings are bored at an angle of about 70° from the axis.
15. The coupler of any one of items 1 to 14, wherein in said first engaged position, the outer sleeve overlays the ball bearings and eventually the outward rim, thereby biasing the ball bearings inwards toward said axis.
16. The coupler of any one of items 1 to 15, wherein the ball bearing engaging end of the outer sleeve is thinner so as to leave a space, between the outer sleeve and the inner sleeve, for accommodating the ball bearings.
17. The coupler of 16, wherein the outer sleeve is between about 0.01 and about 0.06 inch thinner.
18. The coupler of 17, wherein the outer sleeve is about 0.03 inch thinner.
19. The coupler of any one of items 1 to 18, wherein the inner sleeve is comprised of a socket for receiving the tube of the grease gun, attached to a hollow cylindrical member, the socket being bored along said axis.
20. The coupler of 19, wherein the socket is threadably attached to the hollow cylindrical member
21. The coupler of 19 or 20, wherein the socket is threaded for attachment to the tube of the grease gun.
22. The coupler any one of items 1 to 21, wherein in said second disengaged position, a first outward shoulder provided on the piston abuts an inward shoulder provided in the inner sleeve, thereby maintaining the piston within the inner sleeve.
23. The coupler of any one of items 1 to 22, wherein in said first disengaged position, the tube end of the outer sleeve abuts a first outward shoulder provided on the inner sleeve, thereby maintaining the outer sleeve over the inner sleeve.
24. The coupler any one of items 1 to 23, wherein said first means of biasing is a spring abutting on a second outward shoulder provided on the inner sleeve and engaging a second outward shoulder provided on piston.
25. The coupler any one of items 1 to 24, wherein said second means for biasing is a spring encased in a chamber defined by a third outward shoulder provided on the inner sleeve and an inward shoulder in the outer sleeve.
26. The coupler any one of items 1 to 25, wherein said third means for biasing is a spring encased in a chamber defined by an outward shoulder provided on the inner sleeve and an inward shoulder in the outer sleeve.
27. The coupler of any one of items 1 to 26, wherein further comprising a toric joint abutting the piston.
28. The coupler of any one of items 1 to 27, wherein the ball bearings are about 3/32 inch in diameter.

### DETAILED DESCRIPTION OF THE INVENTION

Turning now to the invention in more details, there is provided a grease gun coupler for delivering grease from a tube of a grease gun to a grease fitting.

The inventors have conducted much experimentation and went through many iterations to arrive at the couplers of the invention. Many of the difficulties encountered related to the fact that grease fittings vary in size and length. It has been a challenge to arrive at a solid coupler that (A) allows various grease fittings to penetrate far enough in the coupler and (B) allows ball bearings to penetrate sufficiently inside the coupler neck, so that the various grease fittings are properly secured.

The coupler of the invention comprises an elongated inner sleeve, which has a longitudinal axis and two ends. In use, the grease flows in the coupler along the longitudinal axis. The first end of the inner sleeve is the end to which the tube of the grease gun will attach; it can be called the tube attachment end. The second end is the end that will receive the grease fitting; it can be called the grease fitting accepting end.

In embodiments, the inner sleeve is comprised of a socket attached to a hollow cylindrical member. In further embodiments, the socket is threadably attached to the hollow cylindrical member. The socket is for receiving the tube of the grease gun. It is bored along the longitudinal axis to allow passage of the grease. The socket may be configured to adapt to the tube of any grease gun as desired. In embodiments, the socket is threaded for attachment to the tube of the grease gun.

The coupler also comprises a plurality of ball bearings. There can be 2 or more ball bearings in the coupler, such as for example 4 to 8 ball bearings, for example 5 ball bearings. These ball bearings are located in a corresponding number of openings spread evenly around the circumference of the elongated inner sleeve at its grease fitting accepting end. In embodiments, the size of the openings is about the same as the size of the ball bearings, but only slightly larger to allow movement of the ball bearings. The ball bearings should be a size proper to engage the neck of the grease fitting. In embodiments, the ball bearings are about 3/32 inch in diameter.

In embodiments, the inner sleeve (or hollow cylindrical member) is terminated at its grease fitting accepting end with an outward rim. In further embodiments, the openings are partially defined by the outward rim (which means that the rim constitutes part of the wall of the openings, as shown in FIGS. 1 and 2). The closeness of the openings to the rim increases the number of different grease fittings that can be properly secured in the coupler. Similarly, the small size of the rim increases the number of different grease fittings that can be properly secured in the coupler. In embodiments, the rim has a roughly triangular cross section. In embodiments, the rim is less than about 0.075, 0.06, 0.05, or 0.045 inch in height and less than about 0.060, 0.050, or 0.040 inch in width. In more specific embodiments, the rim has a height of about 0.044 inch and a width of about 0.030 inch. In other embodiments, the rim has a height of about 0.033 inch and a width of about 0.040 inch. In embodiments, the openings are not bored perpendicularly to the longitudinal axis, but are rather bored at an angle of about 60 to about 80° from this axis. In specific embodiments, the openings are bored at an angle of about 70° from the axis. This angle increases the number of different grease fittings that can be properly secured in the coupler.

The coupler comprises an outer ball bearing retaining sleeve that axially slides over the inner sleeve from an engaged position (when the coupler engages a grease fitting) to a disengaged position (when the coupler does not engage a grease fitting). The outer sleeve can be defined as having two ends, a first one, which can be called the “tube end” on the side of the coupler where the tube attaches, and a second one, which can be called the ball bearing engaging end, on the side of the coupler which receives the grease fitting.

In embodiments of this disengaged position, the ball bearing engaging end of the outer sleeve abuts the ball bearings and maintains them in the openings. In more specific embodiments, the ball bearing engaging end of the outer sleeve is partly cut at an angle of about 45. This allows better contact with the ball bearings.

In embodiments of this disengaged position, the tube end of the outer sleeve abuts an outward shoulder provided on the socket and thereby maintains the outer sleeve over the socket and hollow cylindrical member. This prevents the outer sleeve from traveling on the tube of the grease gun. The fact that the outer sleeve extends over the socket is advantageous in cases where grease fittings are in difficult to reach locations. In such embodiments, the outer sleeve is easier to reach and can more easily be manipulated

In embodiments of the engaged position, the outer sleeve overlays the ball bearings and eventually the outward rim, thus biasing the ball bearings inwards toward the longitudinal axis. In more specific embodiments, the ball bearing engaging end of the outer sleeve is thinner so as to leave a space, between the outer sleeve and the inner sleeve, so as to accommodate the ball bearings. For example, this part of the outer sleeve may be between about 0.01 and about 0.06 inch thinner, for example about 0.03 inch thinner.

The coupler also comprises an inner concave piston. This piston retains the ball bearing within the opening (by preventing from falling into the coupler) and accepts the grease fittings. The piston is arranged axially within the inner sleeve and slides within it from an engaged position (when the coupler engages a grease fitting) to a disengaged position (when the coupler does not engage a grease fitting). The piston is bored to allow passage of the grease.

In embodiments of this disengaged position, an outward shoulder provided on the piston abuts an inward shoulder provided in the hollow cylindrical member. This maintains the piston within the hollow cylindrical member when no grease fitting is inserted.

The coupler comprises a first means (such as a spring) for biasing the piston toward the grease fitting accepting end of the inner sleeve. In embodiments, the first means for biasing abuts on an outward shoulder provided on the socket and engages an outward shoulder provided on piston so as to bias the piston.

In embodiments, the coupler also comprises a second means (such as a spring) for biasing the outer sleeve toward its ball bearing engaging end. In such embodiments, the second means for biasing can be encased in a chamber defined by an outward shoulder provided on the socket and an inward shoulder in the outer sleeve. In other embodiments, the coupler rather comprises a third means (such as a spring) for biasing the outer sleeve toward its tube end. In such embodiments, the third means for biasing can be encased in a chamber defined by an outward shoulder provided on the inner sleeve and an inward shoulder in the outer sleeve.

The passage of the grease in the coupler is along the longitudinal axis and is defined by the inner sleeve (or the socket and cylindrical member) and the piston. In embodiments, the passage for the grease is unhindered along this axis, which eases the delivery of the grease.

In using a coupler according to the embodiments above comprising the second means for biasing, an operator first pushes the coupler against a grease fitting. The grease fitting thus inserted in the coupler pushes the piston inside the coupler (i.e. away from the grease fitting accepting end) to its engaged position. At the same time, the second means for biasing pushes the outer sleeve toward its ball bearing engaging end to its first engaged position. When the head of the grease fitting has passed the openings for the ball bearings, the ball bearings are pushed inwards by the outer sleeve and thus engage the neck of the grease fitting. In this position, the outer sleeve holds the ball bearings inwards, which secures the grease fitting in the coupler. With the coupler thus locked on the grease fitting, the operator may let go of the coupler, which constitutes an advantage of the invention. This frees both of the operator's hand, which he can use to hold the gun and pump the handle to deliver grease. To detach the coupler from the grease fitting, the operator simply retracts of the outer sleeve away from its ball bearing engaging end to its disengaged position. This releases the ball bearings, which in turn allow the first means for biasing to push the piston toward the grease fitting accepting end to its disengaged position. The piston thereby expels the grease fitting from the coupler.

In using a coupler according to the embodiments above comprising the third means for biasing, an operator again pushes the coupler against a grease fitting. The grease fitting thus inserted in the coupler pushes the piston inside the coupler (i.e. away from the grease fitting accepting end) to its engaged position. When the head of the grease fitting has passed the openings for the ball bearings, the ball bearings fall inwards and engage the neck of the grease fitting. Then, the operator pushes the outer sleeve toward its ball bearing engaging end to its first engaged position. The outer sleeve is maintained in this position (despite the bias by the third means for biasing) by the outward pressure exerted by the ball bearings. This secures the grease fitting in the coupler. With the coupler thus locked on the grease fitting, the operator may let go of it. To detach the coupler from the grease fitting, the operator simply pushes the inner sleeve towards its grease fitting accepting end so that the outer sleeve is in its disengaged position. It should be noted that this can easily be accomplished by pushing the tube of the grease gun toward the grease fitting since the inner sleeve is attached to the tube. It should also be noted that in this operation, the outer sleeve does not move. This movement is thus equivalent to retracting the outer sleeve over the inner sleeve. In any case, this releases the ball bearings, which in turn allow the first means for biasing to push the piston toward the grease fitting accepting end to its disengaged position. The piston thereby expels the grease fitting from the coupler.

This configuration comprising a piston that is concave and biased toward any grease fitting to be inserted in the coupler and the ball bearings biased inwards has significant advantages. First, it eliminates the need for alignment of the coupler and grease fitting prior to insertion of the grease fitting in the coupler. The concavity of the piston, the wall of the inner sleeve in which the grease fitting and piston are pushed, and the pressure exerted by the ball bearings cooperate to bring the grease fitting into a proper alignment and to maintain it in this alignment. Further, the concavity of the piston and the fact that the piston is biased toward any inserted grease fitting ensure a proper seal between the coupler and the grease fitting. As such, the coupler of the invention provides a good seal with grease fittings of various lengths and sizes.

In embodiments, the outer sleeve is provided with a lip to improve grip for retraction. In these or other embodiments, at least part of the surface of the outer sleeve is knurled to improve grip for retraction.

The coupler of the invention can be installed and uninstalled with only one hand. These quick and easy connection and disconnection constitute another advantageous feature of the invention. This connection mechanism also reduces the wear of the various parts of the coupler.

When build with closed tolerances, this mechanism does not require any seal, which can prolong the useful life of the coupler. Otherwise, known sealing means, such as toric joints (O-rings), can be used.

It will be apparent to the skilled person that the coupler of the invention comprises a reduced number of parts and is very easy to assemble.

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a longitudinal cross-sectional view of a coupler, according to an embodiment of the invention, at rest and accompanied by a generic grease fitting;

FIG. 2 is a longitudinal cross-sectional view of a coupler, according to another embodiment of the invention, at rest and accompanied by the generic grease fitting;

FIG. 3 is a longitudinal cross-sectional view of the coupler shown in FIG. 1 engaged to the generic grease fitting;

FIG. 4 is a longitudinal cross-sectional view of the hollow cylindrical member of the embodiment of the coupler shown in FIG. 1;

FIG. 5 is a longitudinal cross-sectional view of the hollow cylindrical member of the embodiment of the coupler shown in FIG. 2;

FIG. 6 is a longitudinal cross-sectional view of the socket of the embodiments of the coupler shown in FIGS. 1, 2, and 12; and

FIG. 7 is a longitudinal cross-sectional view of the outer sleeve of the embodiments of the coupler shown in FIGS. 1 and 2;

FIG. 8 is a longitudinal cross-sectional view of the piston of the embodiments of the coupler shown in FIGS. 1, 2, and 12; and

FIG. 9 is a partial longitudinal cross-sectional view of the piston in the embodiment of the coupler shown in FIGS. 1, 2, and 12, showing the dimensions of the concavity;

FIG. 10 is a transverse cross-sectional view of the socket of the embodiments of the coupler shown in FIGS. 1, 2, and 12;

FIG. 11 is a photograph of the coupler of FIG. 1;

FIG. 12 is a longitudinal cross-sectional view of a coupler, according to an embodiment of the invention, at rest and accompanied by a generic grease fitting;

FIG. 13 is a longitudinal cross-sectional view of the coupler shown in FIG. 12 engaged to the generic grease fitting;

FIG. 14 is a longitudinal cross-sectional view of the hollow cylindrical member of the embodiment of the coupler shown in FIG. 12; and

FIG. 15 is a longitudinal cross-sectional view of the outer sleeve of the embodiment of the coupler shown in FIG. 12.

### DESCRIPTION OF ILLUSTRATIVE EMBODIMENTS

The present invention is illustrated in further details by the following non-limiting example.

### LIST OF PARTS

(10) coupler
(12) socket
(14) hollow cylindrical member
(16) threads of the socket (12) for attachment to a tube of a grease gun
(18) threads of the socket (12) for attachment to the hollow cylindrical member (14)
(20) threads of the hollow cylindrical member (14) for attachment to the socket (12)
(24) longitudinal axis of the elongated inner sleeve
(26) tube attaching end of the elongated inner sleeve (for attachment to the tube of the grease gun)
(28) grease fitting accepting end of the elongated inner sleeve
(30) bore in the socket (12)
(32) ball bearings
(34) openings spread evenly around the circumference of the grease fitting accepting end (28) of the elongated inner sleeve
(36) outward rim at the grease fitting accepting end (28) of the hollow cylindrical member (14)
(38) outer ball bearing retaining sleeve
(40) tube end of outer sleeve (38)
(42) ball bearing engaging end of outer sleeve (38)
(44) outward shoulder provided on socket (12)
(46) thinner part of outer sleeve (38)
(48) lip provided on outer sleeve (38)
(50) piston
(52) bore in piston (50)
(54) outward shoulder provided on piston (50)
(56) inward shoulder provided in the hollow cylindrical member (14)
(58) spring
(60) outward shoulder provided on the socket (12)
(62) outward shoulder provided on piston (50)
(64) spring
(66) chamber in which spring (64) is located
(68) outward shoulder provided on the socket (12)
(70) inward shoulder in the outer sleeve (38)
(72) cut outs in the socket (12)
(74) washers
(76) toric joint
(78) outward shoulder on the inner sleeve (14)
(80) spring
(82) chamber in which spring (80) is located
(84) inward shoulder in the outer sleeve (38)
(100) generic grease fitting
(102) head of the grease fitting
(104) neck of the grease fitting
(106) body of the grease fitting

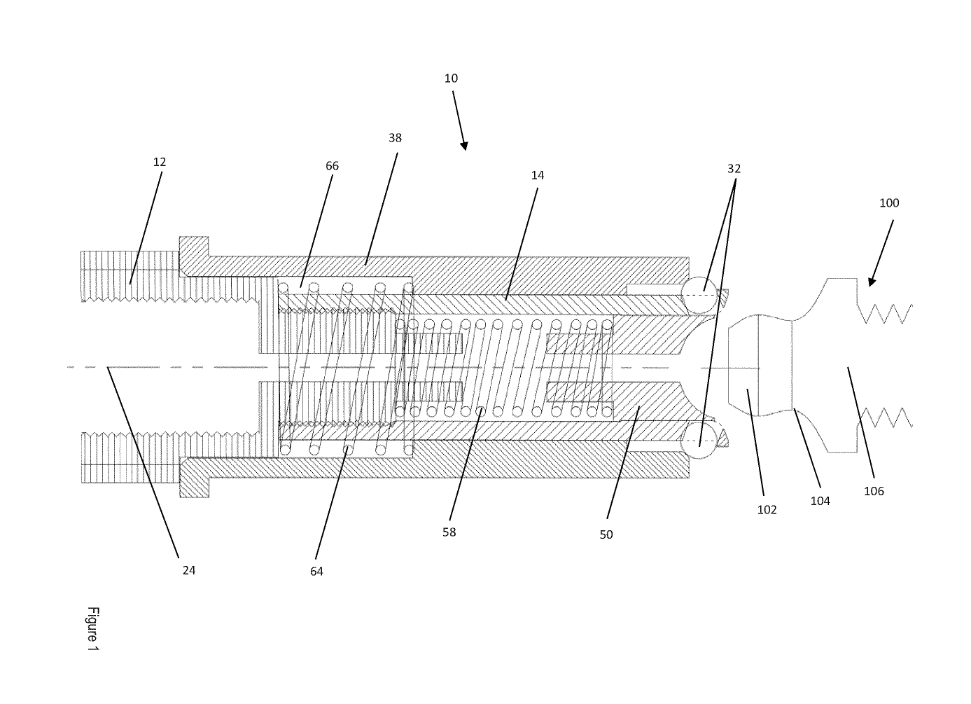

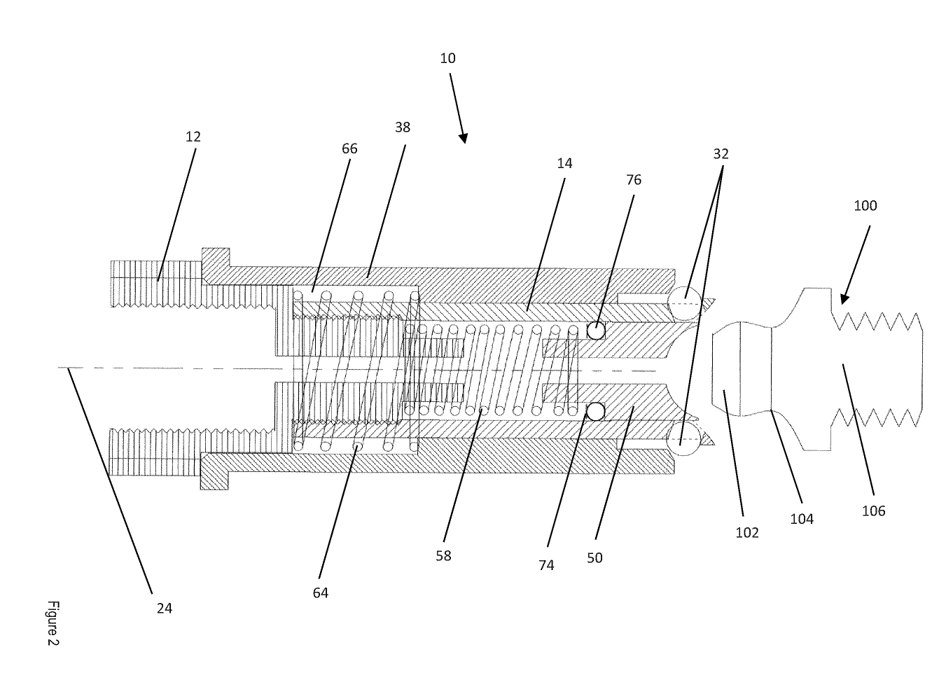

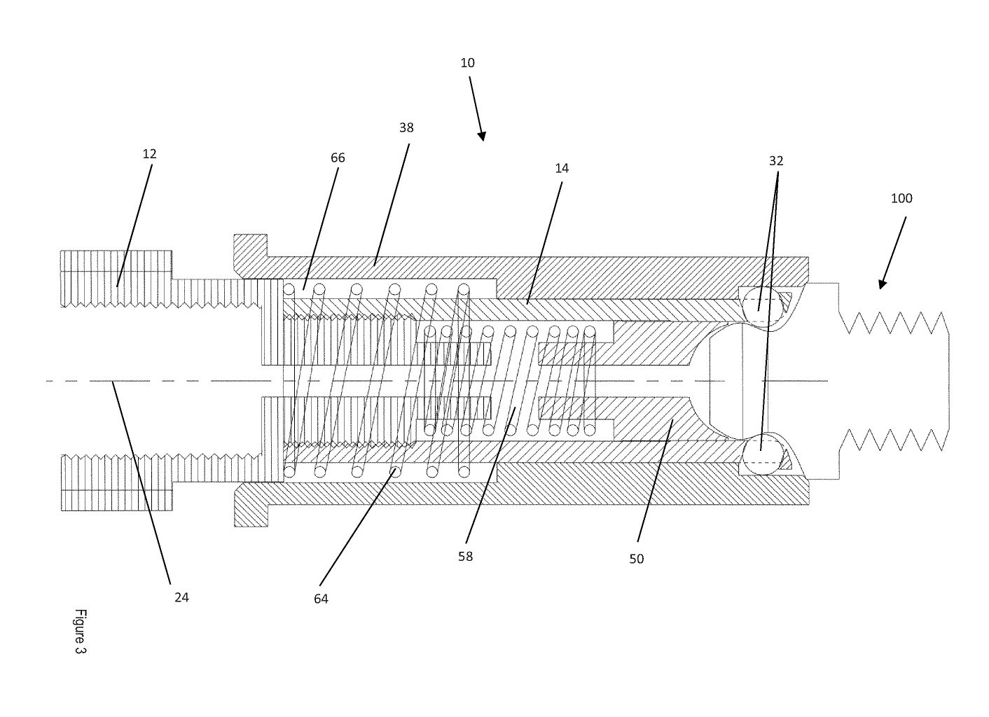

FIGS. 1, 2, and 3 are longitudinal cross-sectional views of a coupler (10) according to two similar embodiments of the invention and accompanied by a generic grease fitting (100). FIGS. 1 and 2 show the coupler (10) at rest, while FIG. 3 shows the coupler (10) according to the embodiment shown in FIG. 1 engaged to the grease fitting (100).

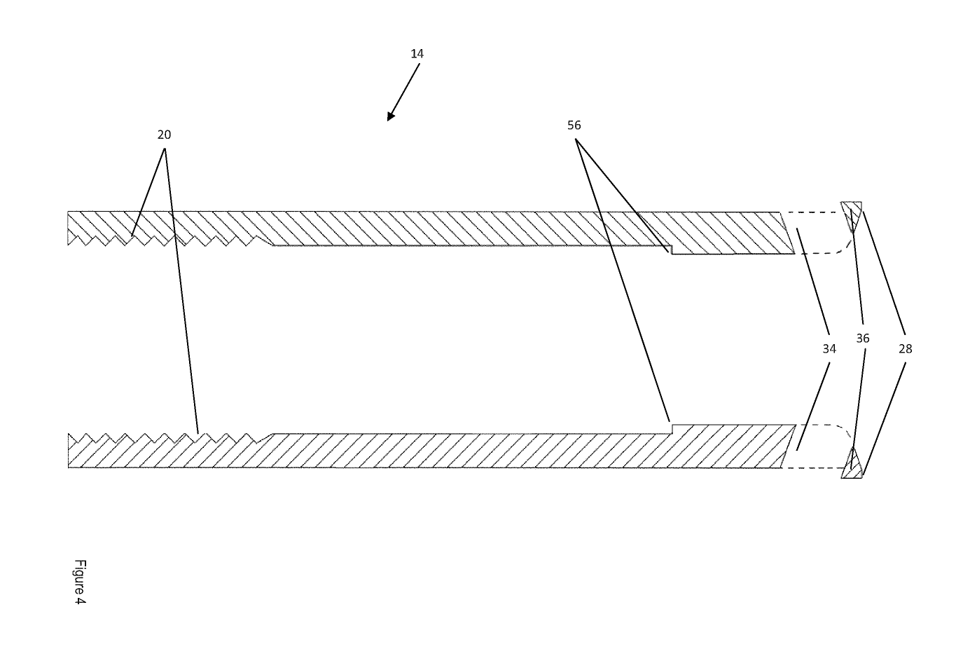

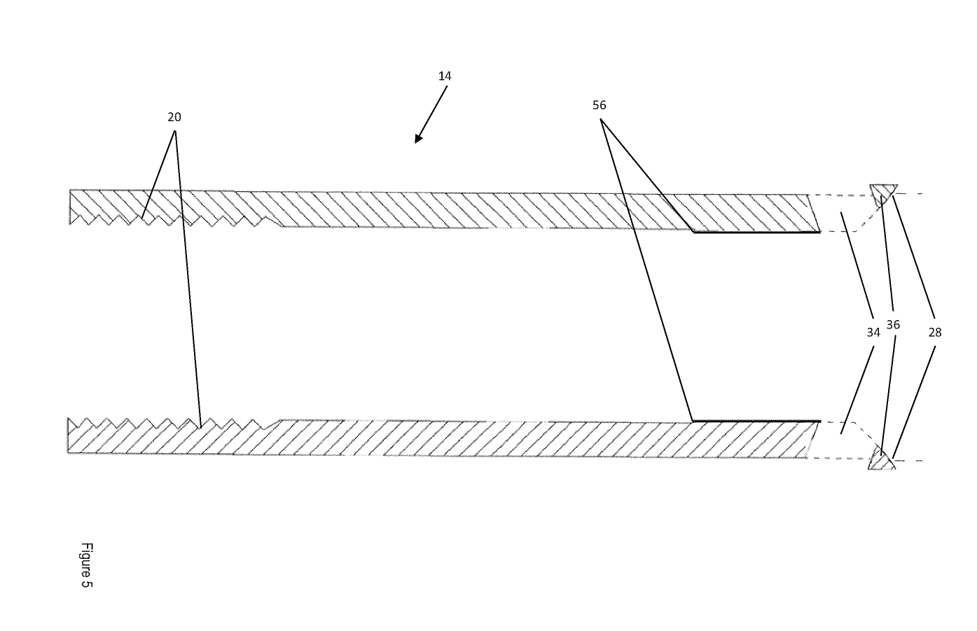

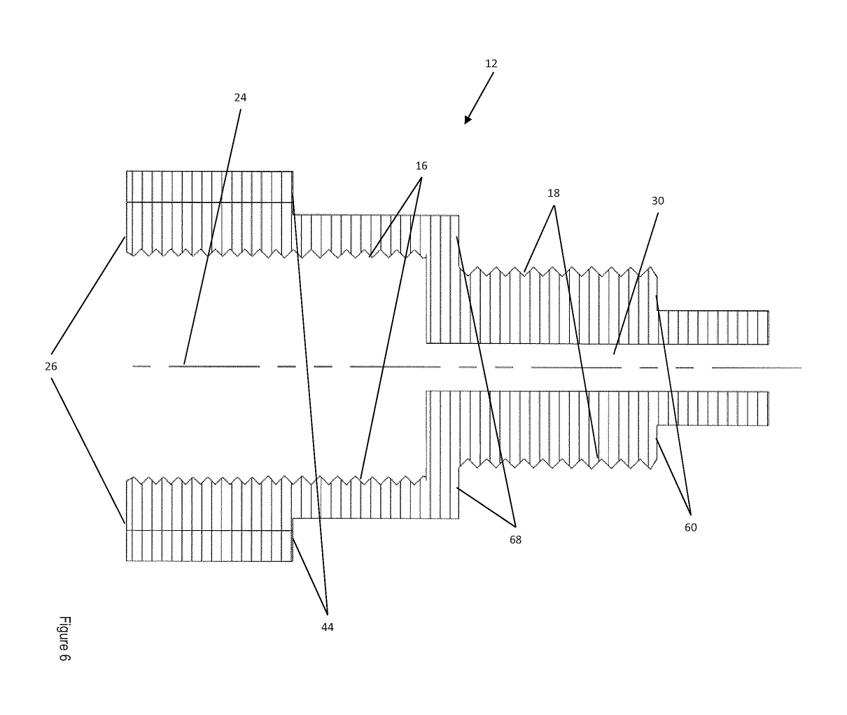

The coupler (10) comprises an elongated inner sleeve consisting of a socket (12) for receiving the tube of the grease gun, attached to a hollow cylindrical member (14). FIG. 4 shows is a longitudinal cross-sectional view of hollow cylindrical member (14) according to the embodiment shown in FIG. 1, while FIG. 5 shows is a longitudinal cross-sectional view of hollow cylindrical member (14) according to the embodiment shown in FIG. 2. FIG. 6 is a longitudinal cross-sectional view of socket (12).

The socket (12) is threaded (16) for attachment to the tube of the grease gun. The socket (12) and the hollow cylindrical member (14) are also threaded (18 and 20, respectively) for mutual attachment. Thus mutually attached, the socket (12) and the hollow cylindrical member (14) form the elongated inner sleeve, which has a longitudinal axis (24), a tube attaching end (26, on the socket (12)) for attachment to the tube of the grease gun and a grease fitting accepting end (28, on the hollow cylindrical member (14)).

The socket (12) is bored (30) along the longitudinal axis (24), which allows passage of the grease.

Ball bearings (32) are located in a corresponding number of openings (34) spread evenly around the circumference of the grease fitting accepting end (28). More specifically, in embodiments, five ball bearings of a size of 3/32 inch are located in five holes 0.094 inch wide, spaced 72 degrees apart. The hollow cylindrical member (14) is terminated with an outward rim (36) at the grease fitting accepting end (28) and the openings (34) are partially defined by the outward rim (36). The openings (34) are bored at an angle of 70 degrees from the longitudinal axis (24). In FIG. 4, the rim is roughly triangular in shape with a height of 0.044 inch and a width of 0.030 inch. In FIG. 5, the rim is roughly triangular in shape with a height of 0.033 inch and a width of 0.040 inch.

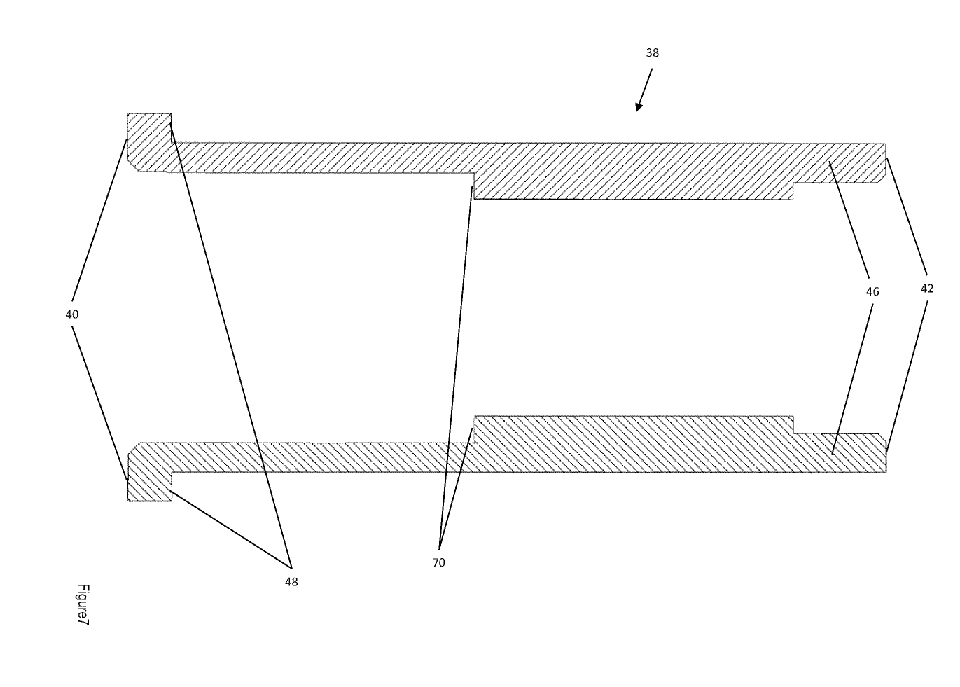

An outer ball bearing retaining sleeve (38) is axially sliding over part of the socket (12) and over the hollow cylindrical member (14). FIG. 7 is a longitudinal cross-sectional view of outer sleeve (38). Outer sleeve (38) has a tube end (40) and a ball bearing engaging end (42).

Outer sleeve (38) slides from a disengaged position shown in FIGS. 1 and 2 to an engaged position shown in FIG. 3. In disengaged position, the tube end (40) of the outer sleeve (38) abuts an outward shoulder (44) provided on the socket (12), which maintains the outer sleeve over the socket (12) and hollow cylindrical member (14). In this position, the ball bearing engaging end (42) of the outer sleeve (38) abuts the ball bearings (32), which maintains the ball bearings (32) in the openings (34). As can be seen in FIG. 7, the ball bearing engaging end (42) of the outer sleeve (38) is partly cut at an angle of about 45° to better engage ball bearings (32). In the engaged position shown in FIG. 3, the outer sleeve (38) overlays the ball bearings (32) and the outward rim (36) of the hollow cylindrical member (14). This biases the ball bearings (32) inwards toward the longitudinal axis (24). As can be seen from this figure, part (46) of outer sleeve (38) is thinner (0.03 inch thinner) at its ball bearing engaging end (42) so as to leave a space, between the outer sleeve (38) and the hollow cylindrical member (14), to accommodate the ball bearings (32).

To improve grip for retraction, the outer sleeve (38) is provided with a lip (48) and part of its surface is knurled.

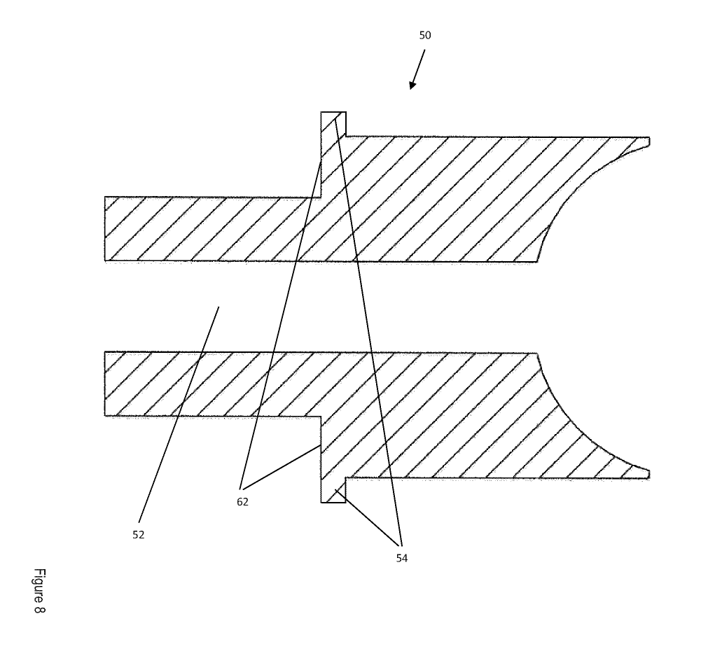

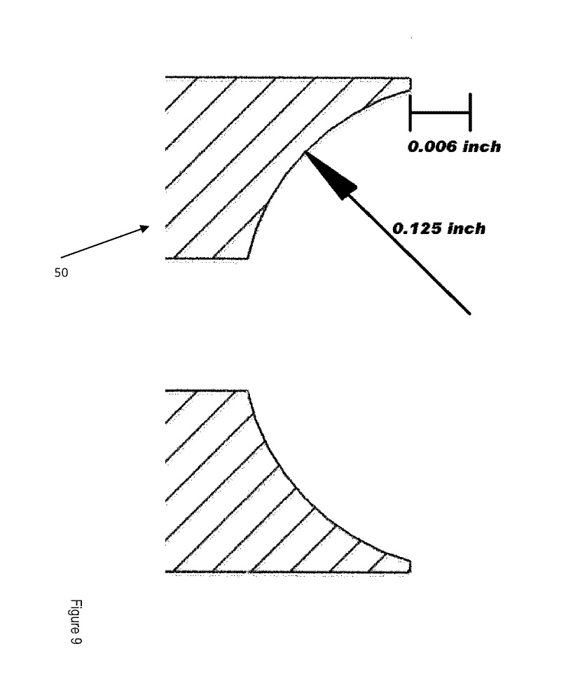

An inner concave ball bearing retaining and grease fitting accepting piston (50) is arranged axially and slides within the hollow cylindrical member (14). FIG. 8 is a longitudinal cross-sectional view of piston (50). FIG. 9 shows the dimensions of the concavity of piston (50). The piston (50) is bored (52) along the longitudinal axis (24), which allows passage of the grease when the coupler is in use. The piston (50) slides from a disengaged position shown in FIGS. 1 and 2 to an engaged position shown in FIG. 3. In disengaged position, an outward shoulder (54) provided on the piston (50) abuts a first inward shoulder (56) provided in the hollow cylindrical member (14), thereby maintaining the piston (50) within it.

A first spring (58) abuts on an outward shoulder (60) provided on the socket (12), engages an outward shoulder (62) provided on piston (50) and thus biases piston (50) toward the grease fitting accepting end (28).

A second spring (64), encased in a chamber (66) defined by an outward shoulder (68) on the socket (12) and an inward shoulder (70) in the outer sleeve (38), biases the outer sleeve (38) toward the grease fitting accepting end (28).

It can be seen from FIGS. 1, 2 and 3 that the socket (12), the hollow cylindrical member (14) and the piston (50) together define an unhindered passage for the grease along the longitudinal axis (24).

In the embodiment shown in FIG. 2, an toric joint (76) and a washer (74) provides a seal between the piston (50) and the hollow cylindrical member (14), preventing grease leaks.

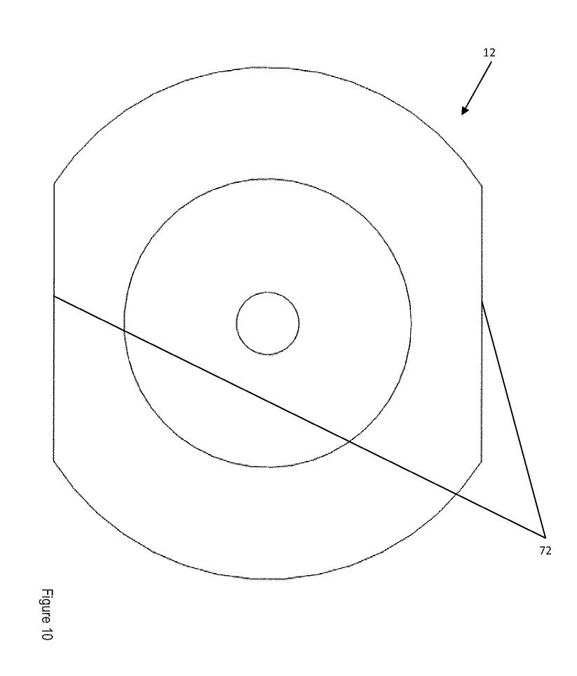

FIG. 10 shows two cut outs on opposite sides of the socket (on part of the socket (12) that is not covered by outer sleeve (38)). These cut outs ease installation of the coupler (10) on the tube of a grease gun using a wrench.

When the coupler (10) is pushed (by an operator) against a grease fitting (100) so as to insert the grease fitting (100) in the coupler (10), the piston (50) is pushed in the coupler (10) (i.e. away from the grease fitting accepting end (28)) to its engaged position, while spring (64) biases the outer sleeve (38) toward the grease fitting accepting end (28) to its engaged position. In this position, the outer sleeve (38) biases the ball bearings (32) inwards toward the longitudinal axis (24). Because of the bulbous shape of grease fittings, this secures the grease fitting (100) in the coupler.

To release grease fitting (100) from the coupler (10), the operator retracts the outer sleeve (38) away from the grease fitting accepting end (28) to its first disengaged position. This releases the ball bearings and thereby allows spring (58) to bias the piston (50) toward the grease fitting accepting end (28) to its second disengaged position. This expels grease fitting (100).

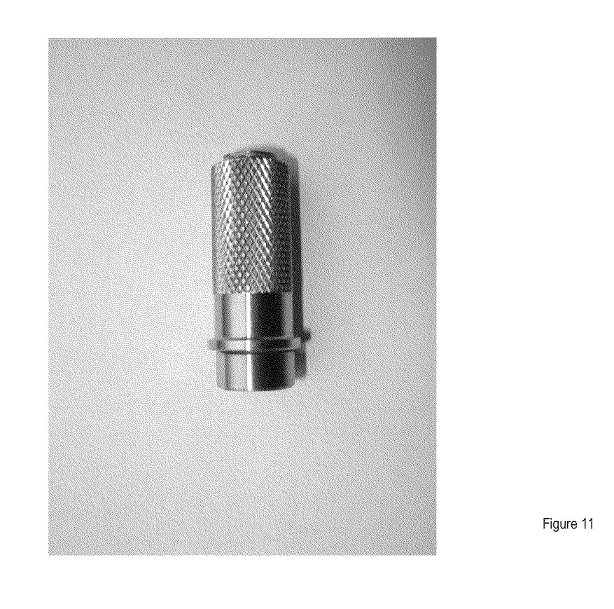

FIG. 11 is a photograph of the coupler as shown in FIG. 1.

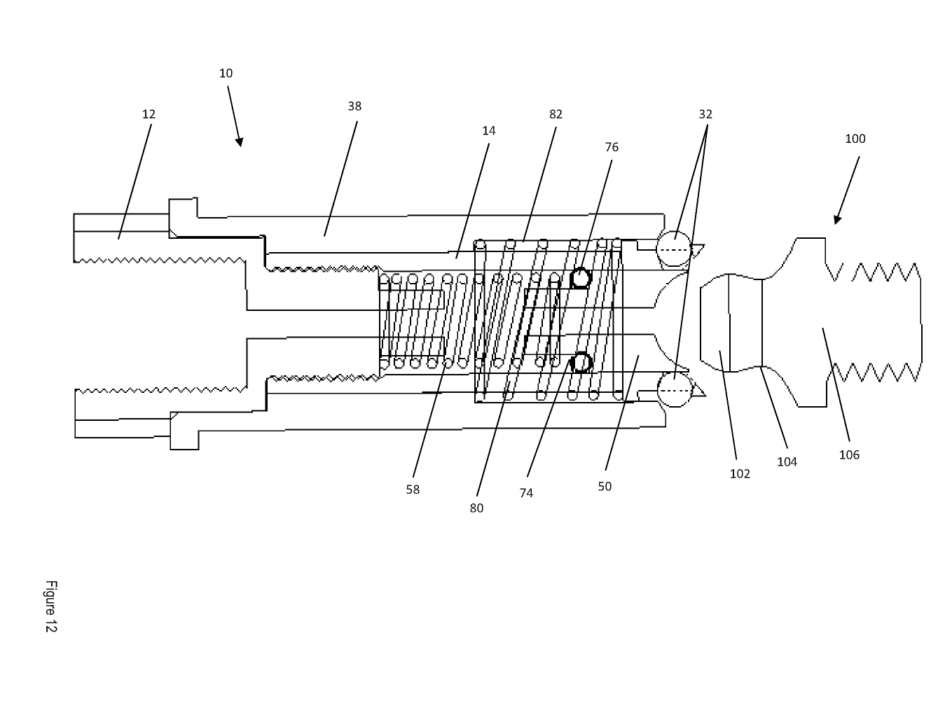

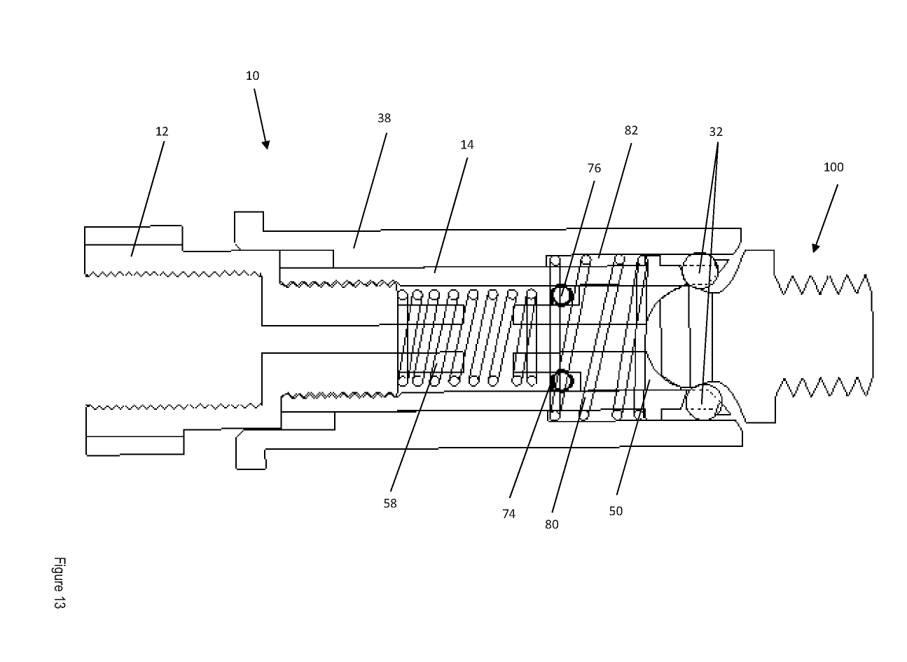

FIGS. 12 and 13 are longitudinal cross-sectional views of a coupler (10) according another embodiment of the invention and accompanied by a grease fitting (100). FIG. 12 shows the coupler (10) at rest, while FIG. 13 shows the coupler (10) engaged to the grease fitting (100).

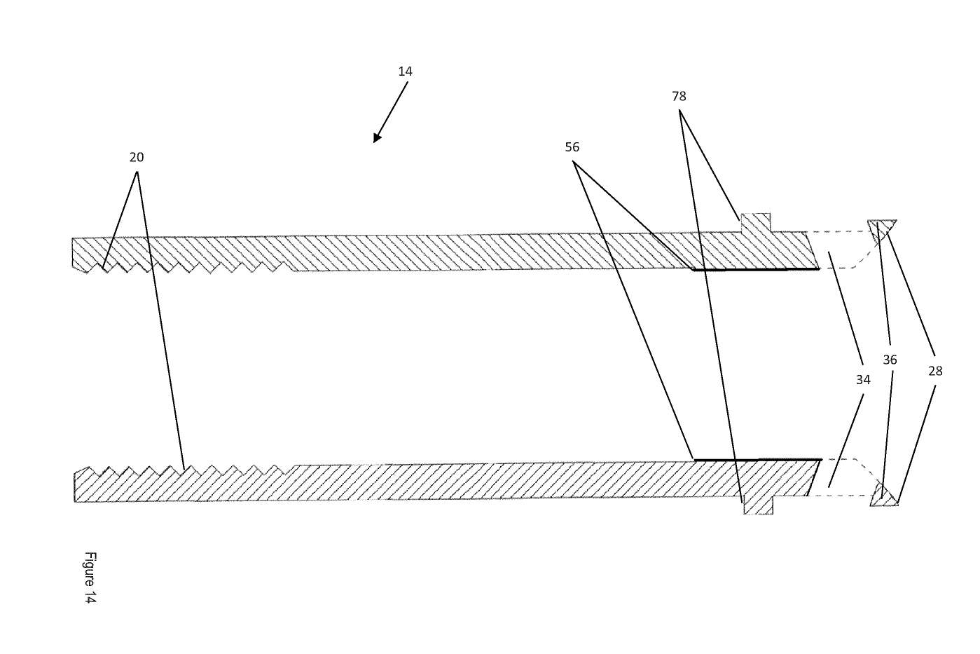

The coupler (10) comprises an elongated inner sleeve consisting of a socket (12) for receiving the tube of the grease gun, attached to a hollow cylindrical member (14). FIG. 14 shows is a longitudinal cross-sectional view of hollow cylindrical member (14) according to the embodiment shown in FIG. 12. The socket (12) is as shown in FIG. 6.

The socket (12) is threaded (16) for attachment to the tube of the grease gun. The socket (12) and the hollow cylindrical member (14) are also threaded (18 and 20, respectively) for mutual attachment. Thus mutually attached, the socket (12) and the hollow cylindrical member (14) form the elongated inner sleeve, which has a longitudinal axis (same as 24 shown in FIG. 1), a tube attaching end (26, on the socket (12)) for attachment to the tube of the grease gun and a grease fitting accepting end (28, on the hollow cylindrical member (14)).

The socket (12) is bored (30) along the longitudinal axis (same as 24 shown in FIG. 1), which allows passage of the grease.

Ball bearings (32) are located in a corresponding number of openings (34) spread evenly around the circumference of the grease fitting accepting end. More specifically, in embodiments, five ball bearings of a size of 3/32 inch are located in five holes 0.094 inch wide, spaced 72 degrees apart. The hollow cylindrical member (14) is terminated with an outward rim (36) at the grease fitting accepting end (28) and the openings (34) are partially defined by the outward rim (36). The openings (34) are bored at an angle of 70 degrees from the longitudinal axis (same as 24 shown in FIG. 1). The rim is roughly triangular in shape with a height of 0.033 inch and a width of 0.040 inch.

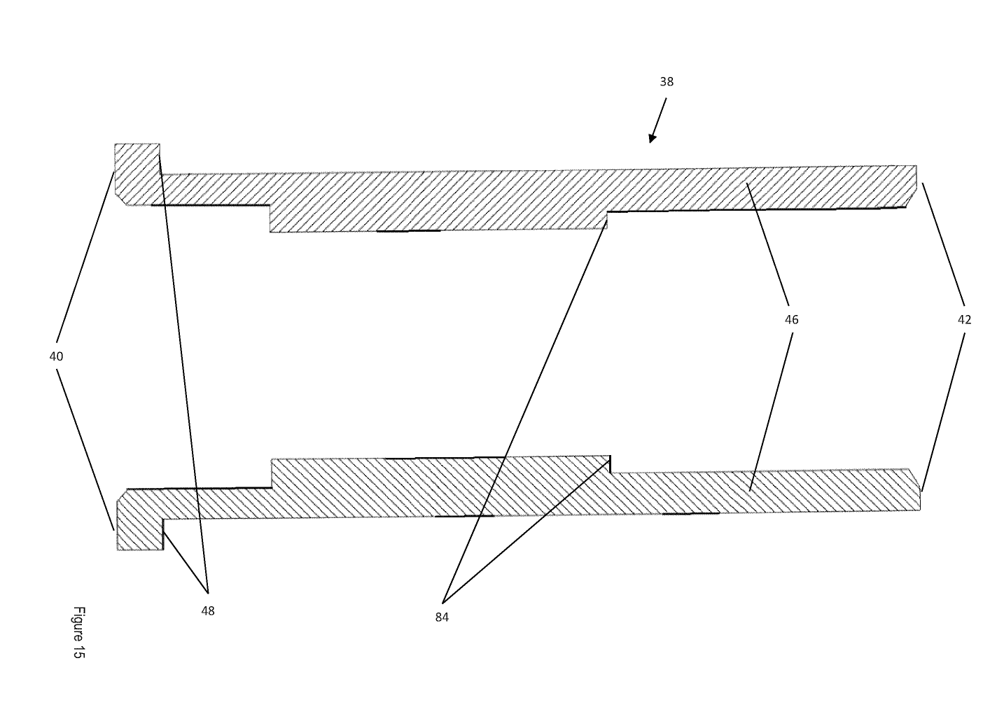

An outer ball bearing retaining sleeve (38) is axially sliding over part of the socket (12) and over the hollow cylindrical member (14). FIG. 15 is a longitudinal cross-sectional view of outer sleeve (38). Outer sleeve (38) has a tube end (40) and a ball bearing engaging end (42).

Outer sleeve (38) slides from a disengaged position shown in FIG. 12 to an engaged position shown in FIG. 13. In disengaged position, the tube end (40) of the outer sleeve (38) abuts an outward shoulder (44) provided on the socket (12), which maintains the outer sleeve over the socket (12) and hollow cylindrical member (14). In this position, the ball bearing engaging end (42) of the outer sleeve (38) abuts the ball bearings (32), which maintains the ball bearings (32) in the openings (34). As can be seen in FIG. 15, the ball bearing engaging end (42) of the outer sleeve (38) is partly cut at an angle of about 45° to better engage ball bearings (32). In the engaged position shown in FIG. 13, the outer sleeve (38) overlays the ball bearings (32) and the outward rim (36) of the hollow cylindrical member (14). This biases the ball bearings (32) inwards toward the longitudinal axis (same as 24 shown in FIG. 1). As can be seen from this figure, part (46) of outer sleeve (38) is thinner (0.03 inch thinner) at its ball bearing engaging end (42) so as to leave a space, between the outer sleeve (38) and the hollow cylindrical member (14), to accommodate the ball bearings (32).

To improve grip, the outer sleeve (38) is provided with a lip (48) and part of its surface is knurled.

An inner concave ball bearing retaining and grease fitting accepting piston (50) is arranged axially and slides within the hollow cylindrical member (14). The piston (50) is as shown in FIG. 8. FIG. 9 shows the dimensions of the concavity of piston (50). The piston (50) is bored (52) along the longitudinal axis (24), which allows passage of the grease when the coupler is in use. The piston (50) slides from a disengaged position shown in FIG. 12 to an engaged position shown in FIG. 13. In disengaged position, an outward shoulder (54) provided on the piston (50) abuts an inward shoulder (56) provided in the hollow cylindrical member (14), thereby maintaining the piston (50) within it.

As shown in FIGS. 12 to 15, a spring (58) abuts on an outward shoulder (60) provided on the socket (12), engages an outward shoulder (62) provided on piston (50) and thus biases piston (50) toward the grease fitting accepting end (28).

In addition, another spring (80), encased in a chamber (82) defined by an outward shoulder (78) on the inner sleeve (14) and an inward shoulder (84) in the outer sleeve (38), biases the outer sleeve (38) toward the tube end (40).

It can be seen from FIG. 12 that the socket (12), the hollow cylindrical member (14) and the piston (50) together define an unhindered passage for the grease along the longitudinal axis (same as 24 shown in FIG. 1).

A toric joint (76) and a washer (74) provide a seal between the piston (50) and the hollow cylindrical member (14), preventing grease leaks.

FIG. 10 shows two cut outs on opposite sides of the socket (on part of the socket (12) that is not covered by outer sleeve (38)). These cut outs ease installation of the coupler (10) on the tube of a grease gun using a wrench.

When the coupler (10) is pushed (by an operator) against a grease fitting (100) so as to insert the grease fitting (100) in the coupler (10), the piston (50) is pushed in the coupler (10) (i.e. away from the grease fitting accepting end (28)) to its engaged position. This allows the ball bearings inwards toward longitudinal axis (24). This in turns allows the operator to push the outer sleeve (38) toward the grease fitting accepting end (28) to its engaged position to secure the grease fitting (100) in the coupler (10). In this position, the outer sleeve (38) biases the ball bearings (32) inwards toward the longitudinal axis (same as 24 shown in FIG. 1). Because of the bulbous shape of grease fittings, this secures the grease fitting (100) in the coupler.

To release grease fitting (100) from the coupler (10), the operator pushes the inner sleeve towards the grease fitting accepting end to its disengaged position. This releases the ball bearings, thereby releasing the grease fitting. This in turns allows spring (58) to bias the piston (50) toward the grease fitting accepting end (28) to its second disengaged position. This expels grease fitting (100).

In making all of the above couplers, the tolerance was generally ±0.005 inch. All parts were made of steel 4140.

These couplers were tested on all the grease fittings the present inventors could find (more than 250 different grease fittings of various origins and age). These include fittings encountered in various garages, including a heavy truck maintenance garage, and fittings from a kit ordered from a foreign country. These couplers were found to work well with all of them. They properly locked on the fittings and did not leak grease. The couplers were tested and found to work with hand-powered and air-powered grease guns. The connection between the grease fittings and the couplers was found to be very strong. In some cases, the operator had to pull on the coupler, in addition to retract the outer sleeve, to disconnect the coupler from the grease fitting.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
CA 330 856;
CA 908 691;
CA 919 727;
CA 932 356;
CA 934 404;
CA 1 095 549;
CA 1 103 721;
CA 1 243 708;
CA 2 025 638;
U.S. Pat. No. 1,383,306;
U.S. Pat. No. 1,468,732;
U.S. Pat. No. 1,848,538;
U.S. Pat. No. 2,104,146;
U.S. Pat. No. 2,314,374;
U.S. Pat. No. 2,425,692;
U.S. Pat. No. 2,673,750;
U.S. Pat. No. 3,788,598;
U.S. Pat. No. 6,412,829;
US 2010/0019493;
GB 222,927;
GB 593,767; and
GB 593,797.

1-28. (canceled)

29. A grease gun coupler for delivering grease from a tube of a grease gun to a grease fitting, the coupler comprising:
an elongated inner sleeve having a longitudinal axis, a tube attaching end and a grease fitting accepting end,
a plurality of ball bearings located in a plurality of openings spread evenly around a circumference at the grease fitting accepting end of the inner sleeve,
an outer ball bearing retaining sleeve axially sliding over the inner sleeve from a first engaged position to a first disengaged position, the outer sleeve having a tube end and a ball bearing engaging end,
an inner concave ball bearing retaining and grease fitting accepting piston arranged axially and sliding within the inner sleeve from a second engaged position to a second disengaged position,
first means for biasing the piston toward the grease fitting accepting end of the inner sleeve, and
second means for biasing the outer sleeve toward the ball bearing engaging end or third means for biasing the outer sleeve toward the tube end,
wherein the inner sleeve and a bore in the piston together define a passage for the grease along said axis, and
wherein insertion of the grease fitting in the coupler biases the piston away from the grease fitting accepting end to said second engaged position, thereby allowing the second means for biasing to bias the outer sleeve toward the ball bearing engaging end to said first engaged position, thereby biasing the ball bearings inwards toward said axis and securing the grease fitting in the coupler, and wherein retraction of the outer sleeve away from the ball bearing engaging end to said first disengaged position releases the ball bearings, thereby allowing the first means for biasing to bias the piston toward the grease fitting accepting end to said second disengaged position, thereby expelling the grease fitting, or
wherein insertion of the grease fitting in the coupler biases the piston away from the grease fitting accepting end to said second engaged position, thereby allowing the ball bearings inwards toward said axis, thereby allowing pushing the outer sleeve toward the ball bearing engaging end to said first engaged position to secure the grease fitting in the coupler, and wherein pushing the inner sleeve towards the grease fitting accepting end so that the outer sleeve is in said first disengaged position releases the ball bearings, thereby allowing the first means for biasing to bias the piston toward the grease fitting accepting end to said second disengaged position, thereby expelling the grease fitting.

30. The coupler of claim 29, wherein in said first disengaged position, the ball bearing engaging end of the outer sleeve abuts the ball bearings, thereby maintaining the ball bearings in the openings.

31. The coupler of claim 29, wherein the passage for the grease is unhindered along said axis.

32. The coupler of claim 29, wherein the outer sleeve is provided with a lip to improve grip.

33. The coupler of claim 29, wherein the ball bearing engaging end of the outer sleeve is partly cut at an angle of about 45.

34. The coupler of claim 29, wherein the inner sleeve is terminated with an outward rim at the grease fitting accepting end.

35. The coupler of claim 34, wherein the openings are partially defined by the outward rim.

36. The coupler of claim 34, wherein the rim has a roughly triangular cross section.

37. The coupler of claim 29, wherein the openings are bored at an angle of about 60 to about 80° from the axis.

38. The coupler of claim 29, wherein in said first engaged position, the outer sleeve overlays the ball bearings and eventually the outward rim, thereby biasing the ball bearings inwards toward said axis.

39. The coupler of claim 29, wherein the ball bearing engaging end of the outer sleeve is thinner so as to leave a space, between the outer sleeve and the inner sleeve, for accommodating the ball bearings.

40. The coupler of claim 29, wherein the inner sleeve is comprised of a socket for receiving the tube of the grease gun, attached to a hollow cylindrical member, the socket being bored along said axis.

41. The coupler of claim 40, wherein the socket is threadably attached to the hollow cylindrical member

42. The coupler of claim 40, wherein the socket is threaded for attachment to the tube of the grease gun.

43. The coupler of claim 29, wherein in said second disengaged position, a first outward shoulder provided on the piston abuts an inward shoulder provided in the inner sleeve, thereby maintaining the piston within the inner sleeve.

44. The coupler of claim 29, wherein in said first disengaged position, the tube end of the outer sleeve abuts a first outward shoulder provided on the inner sleeve, thereby maintaining the outer sleeve over the inner sleeve.

45. The coupler of claim 29, wherein said first means of biasing is a spring abutting on a second outward shoulder provided on the inner sleeve and engaging a second outward shoulder provided on piston.

46. The coupler of claim 29, wherein said second means for biasing is a spring encased in a chamber defined by a third outward shoulder provided on the inner sleeve and an inward shoulder in the outer sleeve.

47. The coupler of claim 29, wherein said third means for biasing is a spring encased in a chamber defined by an outward shoulder provided on the inner sleeve and an inward shoulder in the outer sleeve.

48. The coupler of claim 29, wherein further comprising a toric joint abutting the piston.
